(19) United States
(12) Patent Application Publication
(10) Pub. No.: US 2005/0150987 A1
(43) Pub. Date: Jul. 14, 2005

(54) Tip plate of a rotor and vertical shaft impact crusher having the same

(76) Inventors: Hong-Soon Hur, Daegu-si (KR); Jin-Hee Hur, Seoul (KR)

Correspondence Address: CANTOR COLBURN LLP, 55 Griffin Road South, Bloomfield, CT, 06002, US

(21) Appl. No.: 10/911,772

(22) Filed: Aug. 4, 2004

(30) Foreign Application Priority Data
Jan. 13, 2004 (KR) 2004-2190

(51) Int. Cl. B02C 19/00

(52) U.S. Cl. 241/275

(57) ABSTRACT

A tip plate of a rotor includes a shank disposed at an exit of a rotor that provides centrifugal force to an aggregate, and a tip for preventing wear of the shank combined with the shank. A groove in which the tip is received is provided at a surface of the shank. The groove has an upper portion having an upper width, and a lower portion having a lower width that is greater than the upper width. The tip has a shape corresponding to that of the groove.

### CROSS REFERENCE TO RELATED APPLICATION

This application claims priority under 35 USC § 119 to Korean Patent Application No. 2004-2190, filed on Jan. 13, 2004, the content of which is herein incorporated by reference in its entirety for all purposes.

### BACKGROUND OF THE INVENTION

1. Field of the Invention

The present invention relates to a tip plate of a rotor and a vertical shaft impact crusher having the same. More particularly, the present invention relates to a tip plate of a rotor that provides a centrifugal force to an aggregate for pulverizing the aggregate into gravels and sands, and a vertical shaft impact crusher having the tip plate.

2. Description of the Related Art

A natural aggregate is pulverized using a crusher in accordance with various applications. The crusher includes a vertical shaft impact crusher. The vertical shaft impact crusher pulverizes the natural aggregate by crushing the highly accelerated aggregate against a crushing face. The vertical shaft impact crusher is divided into an anvil type crusher and a rock-on-rock type crusher.

FIGS. 1 to 3 are cross sectional views illustrating a conventional anvil type impact crusher that is disclosed in U.S. Pat. No. 5,135,177.

FIG. 1 is a cross sectional view illustrating a conventional anvil type impact. With reference to FIG. 1, a conventional impact crusher includes a crushing chamber 1 and a feeding hopper 2 disposed over the crushing chamber 1. A rotor 3 for providing a centrifugal force to an aggregate is disposed in the crushing chamber 1. The aggregate is loaded into the rotor 3 through the feeding hopper 2. An anvil 4 is mounted on an inner wall of the crushing chamber 1. The aggregate received the centrifugal force is crushed against the anvil 4.

FIG. 2 is a cross sectional view illustrating the rotor in FIG. 1. With reference to FIG. 2, the rotor 3 includes a rotational shaft 9 receiving a rotary force from a motor (not shown). Three guiding plates 5 for guiding the aggregate in a horizontal direction are disposed in the rotor 3. Thus, the rotor 3 has three exits 8 divided by the guiding plates 5.

The aggregate is rapidly discharged through the exits 8. Accordingly, the aggregate does great damage to ends of the guiding plates 5 adjacent to the exits 8, thereby reducing life span of the guiding plates 5. To prevent the life span of the guiding plates 5 from reducing, a tip plate or a rotor tip is mounted on the ends of the guiding plates 5.

FIG. 3 is a cross sectional view illustrating the tip plate in FIG. 2. With reference to FIG. 3, the conventional tip plate includes a shank 6 at which a groove is provided, and a tip 7 inserted into the groove. The tip 7 having a high hardness, such as hard metal, prevents the rapid wear of the shank 6 against which the aggregate is crushed.

The groove has a rectangular shape. Thus, the tip 7 also has a rectangular shape. When the tip 7 is merely inserted into the groove, the tip 7 is separated from the groove in rapid rotation of the tip 7. Accordingly, securing the tip 7 to an inner wall of the groove is required.

In the conventional vertical shaft impact crusher, a solid silver solder is interposed between the inner wall of the groove and the tip 7. A blazing process is performed on the solid silver solder at a temperature of about 800° C. to about 900° C. to form a liquefied silver solder. The liquefied silver solder is uniformly distributed on an interface between the inner wall of the groove and the tip 7. The liquefied silver solder is cooled to secure the tip 7 to the inner wall of the groove.

When the solid silver solder is heated at a high temperature, the tip 7 having a high hardness is cracked due to the high temperature. Properties of the shank 6 and the tip 7 are also changed owing to the high temperature so that the interface between the shank 6 and the tip 7 has a low hardness. To prevent the crack of the tip 7, using the tip 7 having a low hardness is required. However, the tip having a low hardness has a short life span.

Further, the blazing process for heating the solid silver solder is required. Additionally, time for uniformly distributing the silver solder is needed. Particularly, to prevent the shank 6 and the tip 7 from oxidizing, a flux is coated on the shank 6 and the tip 7. Noxious gases are also produced from the flux in the blazing process.

### SUMMARY OF THE INVENTION

The present invention provides a tip plate of a rotor that is directly combined with a shank without applying silver solder.

The present invention also provides a vertical shaft impact crusher having the tip plate.

A tip plate of a rotor in accordance with one aspect of the present invention includes a shank disposed at an exit of a rotor that provides centrifugal force to an aggregate, and a tip for preventing wear of the shank combined with the shank. A groove in which the tip is received is provided at a surface of the shank. The groove has an upper portion having an upper width, and a lower portion having a lower width that is greater than the upper width. The tip has a shape corresponding to that of the groove.

A vertical shaft impact crusher in accordance with another aspect of the present invention includes a crushing housing. A feeding hopper for providing an aggregate into the crushing housing is disposed over the crushing housing. A rotor for providing a centrifugal force to the aggregate is disposed in the crushing housing. The rotor includes a rotor housing, and a guiding plate for providing an exit at the rotor housing disposed in the rotor housing. A shank is mounted on an end of the guiding plate adjacent to the exit. The shank includes a groove having an upper portion that has an upper width, and a lower portion that has a lower width greater than the upper width. A tip having a shape that corresponds to the shape of the groove is received in the groove. An anvil against which the aggregate discharged through the exit is crushed is mounted on an inner wall of the crushing housing.

According to the present invention, the tip is directly combined with shank without applying silver solder. Therefore, a blazing process for heating the silver solder is omitted in the present invention. As a result, cracking the tip owing to a high temperature in the blazing process is prevented.

### BRIEF DESCRIPTION OF THE DRAWINGS

The above and other features and advantages of the invention will become readily apparent by reference to the following detailed description when considered in conjunction with the accompanying drawings wherein:

FIG. 1 is a cross sectional view illustrating a conventional vertical shaft impact crusher;

FIG. 2 is a cross sectional view illustrating a rotor in FIG. 1;

FIG. 3 is a cross sectional view illustrating a tip plate in FIG. 1;

FIG. 4 is an exploded cross sectional view illustrating a tip plate in accordance with a first embodiment of the present invention;

FIG. 5 is a combined cross sectional view illustrating the tip plate in accordance with the first embodiment of the present invention;

FIG. 6 is a perspective view illustrating the tip plate in accordance with the first embodiment of the present invention;

FIG. 7 is a cross sectional view illustrating a rotor having the tip plate in FIG. 6;

FIG. 8 is a cross sectional view illustrating a vertical shaft impact crusher having the rotor in FIG. 7;

FIG. 9 is an exploded cross sectional view illustrating a tip plate in accordance with a second embodiment of the present invention;

FIG. 10 is a combined cross sectional view illustrating the tip plate in accordance with the second embodiment of the present invention;

FIG. 11 is a perspective view illustrating the tip plate in accordance with the second embodiment of the present invention;

FIG. 12 is an exploded cross sectional view illustrating a tip plate in accordance with a third embodiment of the present invention;

FIG. 13 is a combined cross sectional view illustrating the tip plate in accordance with the third embodiment of the present invention;

FIG. 14 is a perspective view illustrating the tip plate in accordance with the third embodiment of the present invention;

FIG. 15 is an exploded cross sectional view illustrating a tip plate in accordance with a fourth embodiment of the present invention;

FIG. 16 is a combined cross sectional view illustrating the tip plate in accordance with the fourth embodiment of the present invention; and

FIG. 17 is a perspective view illustrating the tip plate in accordance with the fourth embodiment of the present invention;

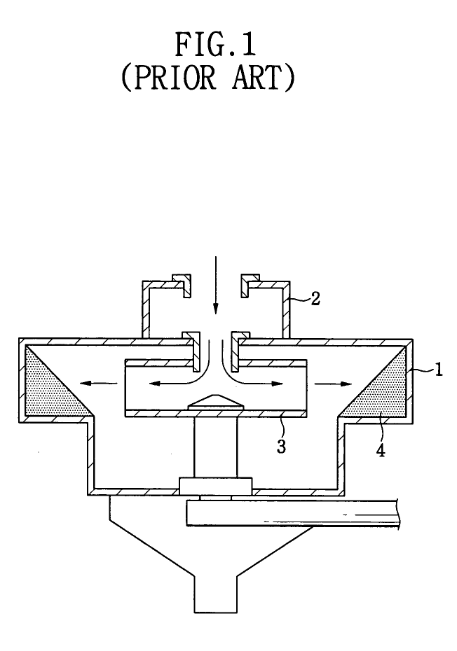

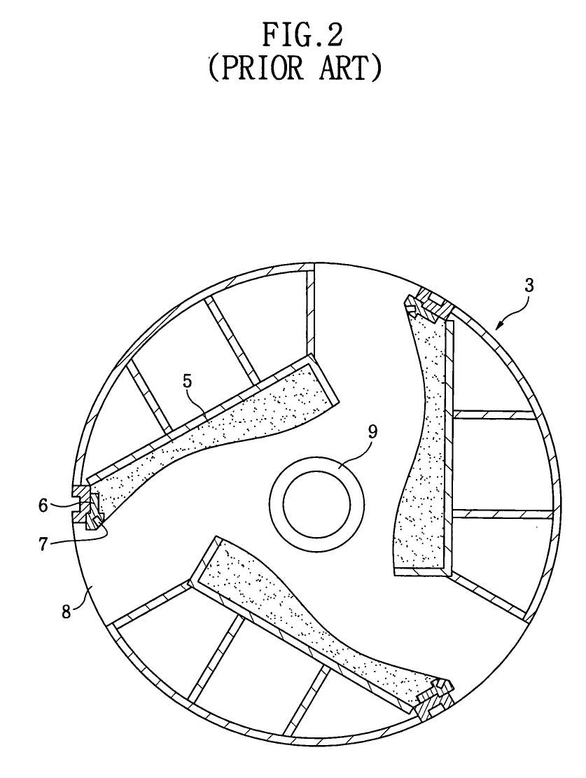

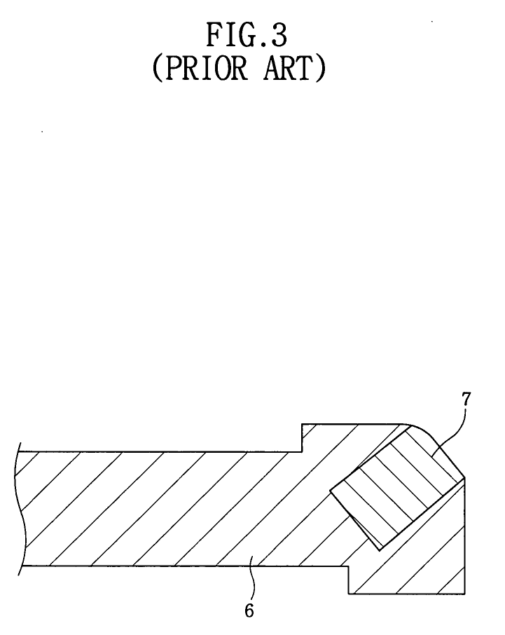

### DESCRIPTION OF THE PREFERRED EMBODIMENTS

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to similar or identical elements throughout.

Hereinafter, a tip plate of a rotor and a vertical shaft impact crusher having the tip plate in accordance with embodiments of the present invention are illustrated in detail.

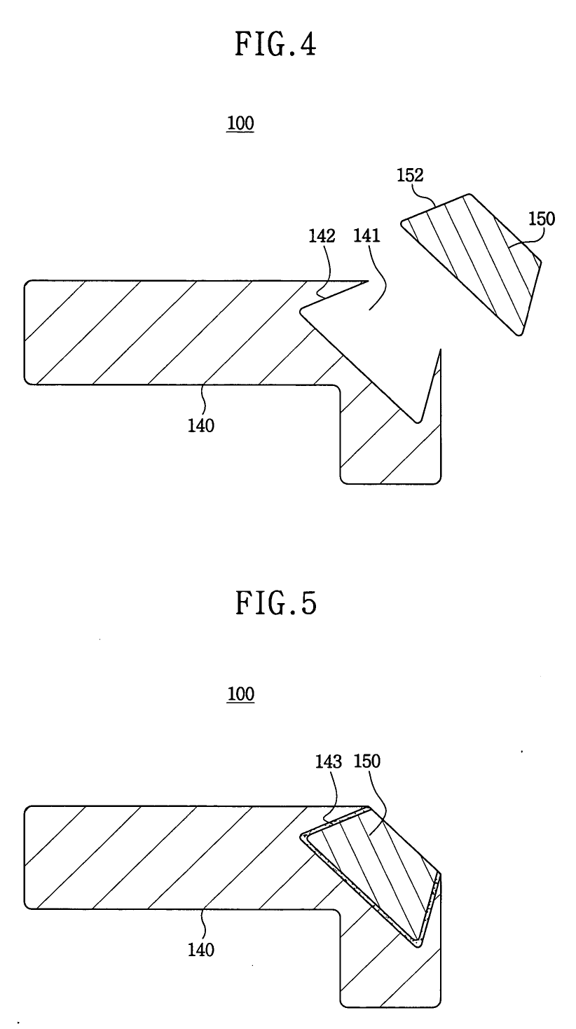

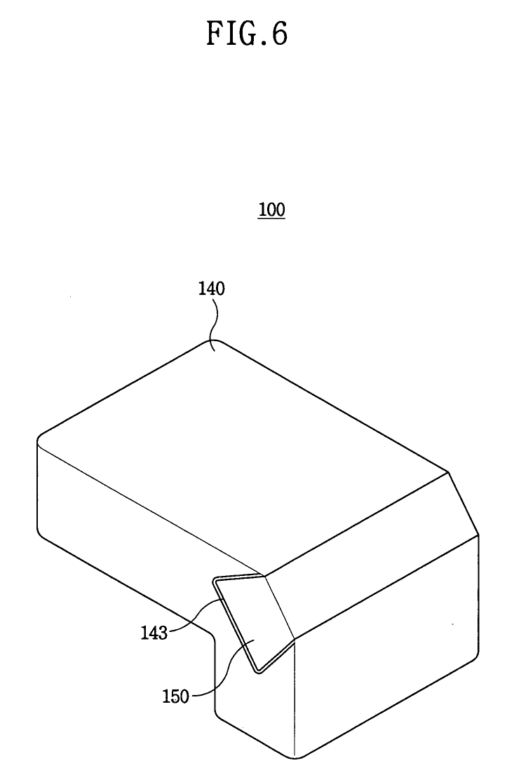

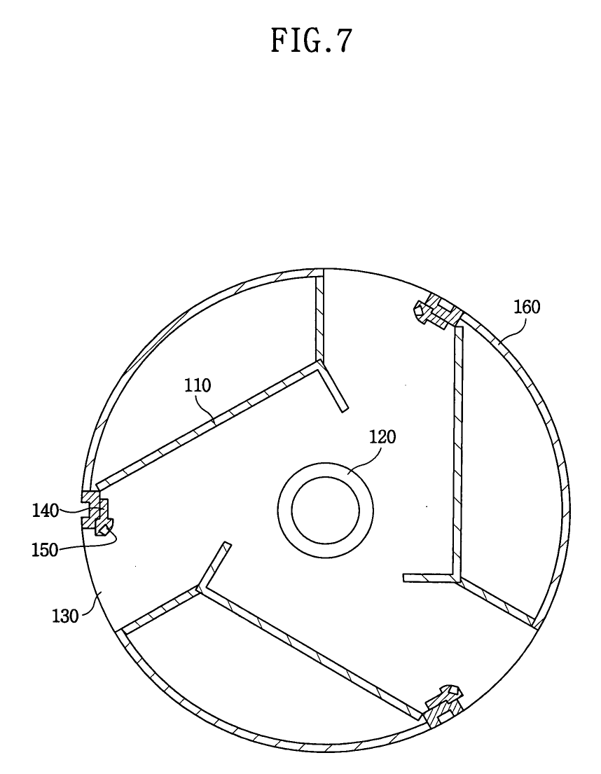

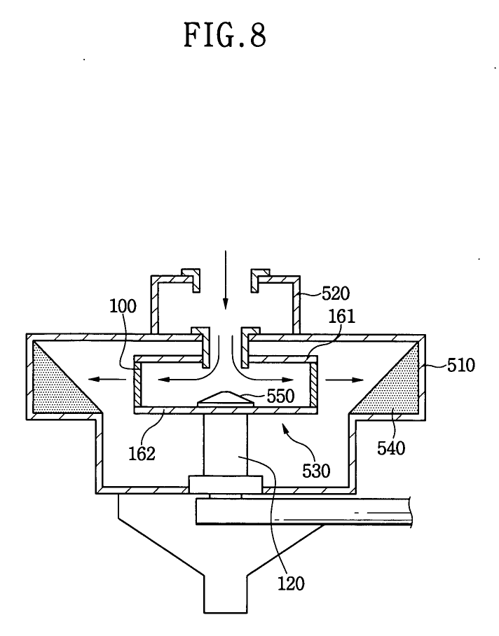

FIG. 4 is an exploded cross sectional view illustrating a tip plate in accordance with a first embodiment of the present invention. FIG. 5 is a combined cross sectional view illustrating the tip plate in accordance with the first embodiment of the present invention. FIG. 6 is a perspective view illustrating the tip plate in accordance with the first embodiment of the present invention. FIG. 7 is a cross sectional view illustrating a rotor having the tip plate in FIG. 6. FIG. 8 is a cross sectional view illustrating a vertical shaft impact crusher having the rotor in FIG. 7.

Referring to FIG. 4, a tip plate 100 in accordance with a first embodiment of the present invention includes a shank 140 having a bent portion at an angle of about 90°, and a tip 150 combined with the shank 140. The tip 150 prevents a corner of the shank 140 from wearing due to an aggregate. Thus, the tip 150 includes a hard metal such as tungsten carbide.

A groove 141 for receiving the tip 150 is provided at the corner of the shank 140. The groove 141 includes an upper portion having an upper width, and a lower portion having a lower width that is greater than the upper width. In the first embodiment, a width of the groove 141 gradually increases from a surface of the shank 140 to an inside of the shank 140. Namely, the groove 141 has a dove tail shape that has tapered side faces 142.

Accordingly, the tip 150 received in the groove 141 has a shape corresponding to that of the groove 141. The tip 150 also has tapered side faces 152.

Referring to FIGS. 5 and 6, the tip 150 is inserted into the groove 141 in a first direction. Thus, the tip 150 may not be separated from the groove 141 in a second direction substantially perpendicular to the first direction. Alternatively, the tip 150 may be separated from the groove 141 the first direction. However, after the tip 150 is assembled to the shank 140, side faces of the shank 140 orienting the first direction are supported with a rotor housing 160 (see FIG. 7) so that the tip 150 is firmly secured to the shank 140 without using silver solder. Additionally, before the tip 150 is supported with the rotor housing, an adhesive 142 may be coated on an inner wall of the groove 141 to prevent the tip 150 from sliding on the inner wall of the groove 141.

Referring to FIGS. 7 and 8, a vertical shaft impact crusher includes a crushing chamber 510, a feeding hopper 520 disposed over the crushing chamber 510, and a rotor 530 disposed in the crushing chamber 510. The rotor 530 includes a rotor housing 160 having a cylindrical shape that is connected to the feeding hopper 520. Thus, the aggregate is loaded into the rotor 530 through the feeding hopper 520. The rotor 530 includes a vertical shaft 120 receiving a rotary force from a motor (not shown). An anvil 540 is mounted on an inner wall of the crushing chamber 510. A distribution member 550 is disposed in the rotor housing 160. The distribution member 550 is connected to the vertical shaft 120 to be rotated together with the rotor housing 160. The distribution member 550 distributes the aggregate in a horizontal direction to crush the aggregate against the anvil 540. The crushed aggregate is pulverized into gravels and sands.

Additionally, The rotor housing 160 has an upper plate 161 and a lower plate 162 disposed under the upper plate 161. The upper plate 161 has an entrance. The aggregate is introduced into a space between the upper and lower plates 161 and 162 through the entrance. The vertical shaft 120 connected to the motor is mounted on a center of the rotor housing 160. The rotor housing 160 is rapidly rotated by the vertical shaft 120 so that the aggregate is discharged from the rotor housing 160. Three guiding plates 110 are disposed between the upper and lower plates 161 and 162. Three exits 130 through which the aggregate is discharged are formed between the guiding plates 110.

The tip plate 100 is mounted on an end of the guiding plate 110 adjacent to the exit 130. Since the aggregate rapidly discharged through the exit 130 is crushed against the tip plate 100, the tip plate 100 has a structure that the tip 150 including the hard metal is combined with the shank 140. The tip 150 inserted into the groove 141 is supported with the upper and lower plates 161 and 162 so that the tip 150 is not separated from the groove 141 in the second direction.

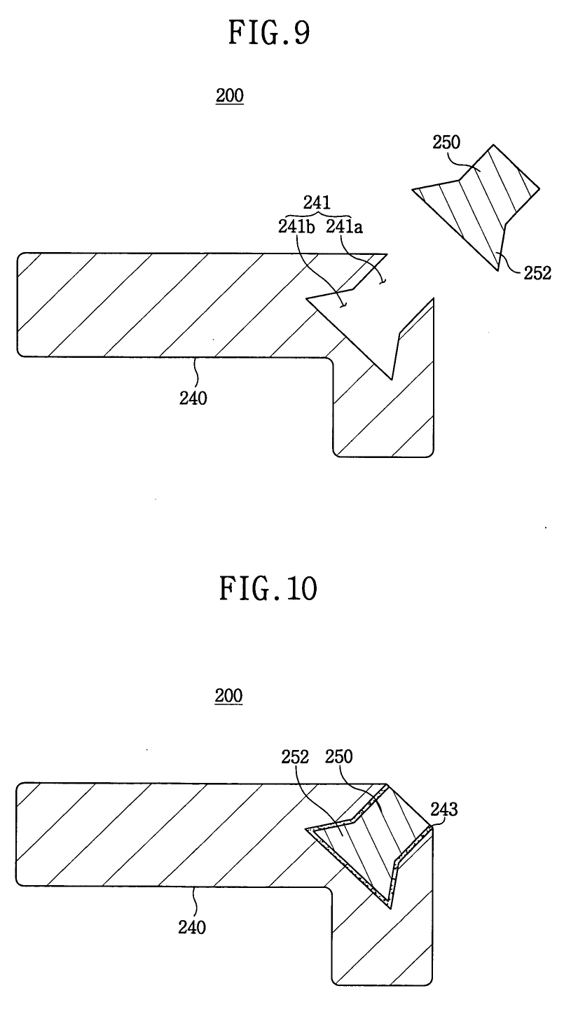

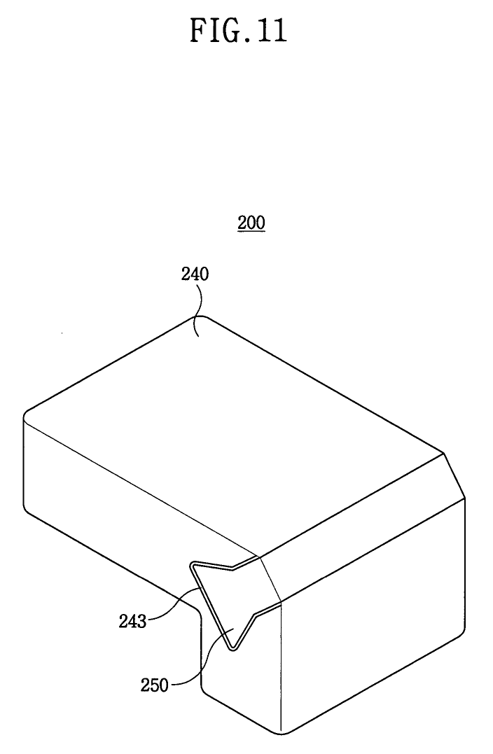

FIG. 9 is an exploded cross sectional view illustrating a tip plate in accordance with a second embodiment of the present invention. FIG. 10 is a combined cross sectional view illustrating the tip plate in accordance with the second embodiment of the present invention. FIG. 11 is a perspective view illustrating the tip plate in accordance with the second embodiment of the present invention.

Referring to FIG. 9, a tip plate 200 in accordance with a second embodiment of the present invention includes a shank 240 having a bent portion, and a tip 250 combined with the shank 240. The tip 250 including tungsten carbide prevents the shank 240 from wearing.

A groove 241 for receiving the tip 250 is provided at the corner of the shank 240. The groove 241 includes a first portion 241a having a first width, and a second portion 241b having a second width that is greater than the first width. The second portion 241b is in communication with the first portion 241a. The second portion 241b has a dove tail shape.

Accordingly, the tip 250 received in the groove 241 has a shape corresponding to that of the groove 241. That is, the tip 250 has a projection 252 having a dove tail shape.

Referring to FIGS. 10 and 11, the tip 250 is inserted into the groove 241 in a first direction. In particular, the projection 252 of the tip 250 is inserted into the second portion 241b of the groove 241 so that separation of the tip 250 from the groove 241 in a second direction that is substantially perpendicular to the first direction is prevented with more secure structure compared to the structure in FIG. 5.

Additionally, an adhesive 243 may be coated on an inner wall of the groove 241. The tip plate 200 may be employed in the rotor and the vertical shaft impact crusher in FIGS. 7 and 8.

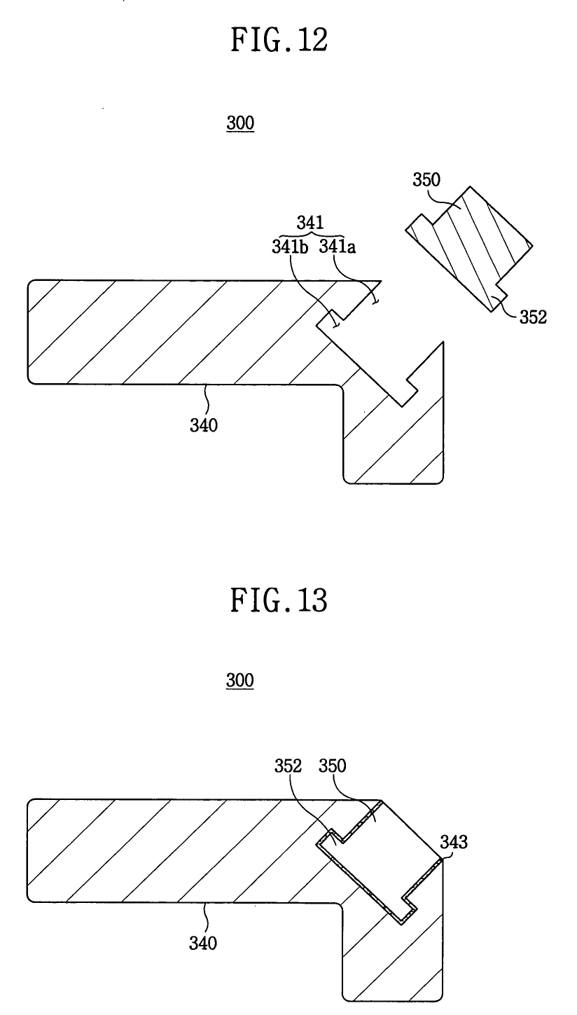

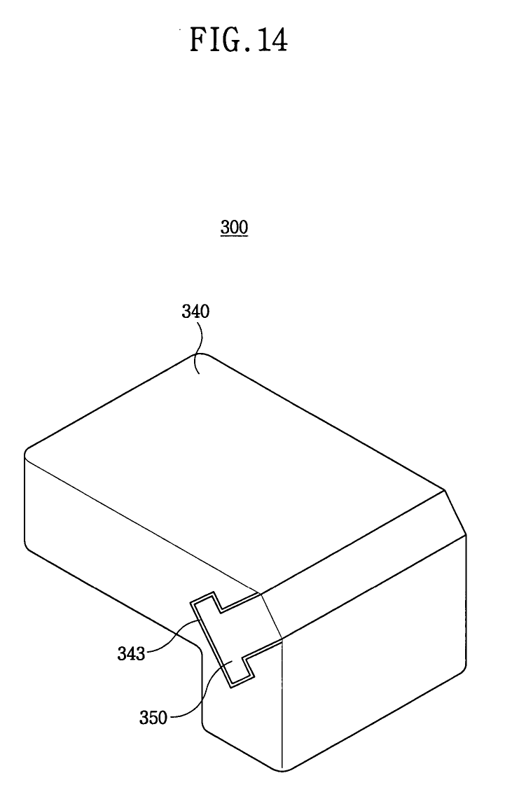

FIG. 12 is an exploded cross sectional view illustrating a tip plate in accordance with a third embodiment of the present invention. FIG. 13 is a combined cross sectional view illustrating the tip plate in accordance with the third embodiment of the present invention. FIG. 14 is a perspective view illustrating the tip plate in accordance with the third embodiment of the present invention.

Referring to FIG. 12, a tip plate 300 in accordance with a third embodiment of the present invention includes a shank 340 having a bent portion, and a tip 350 combined with the shank 340. The tip 350 including tungsten carbide prevents the shank 340 from wearing.

A groove 341 for receiving the tip 350 is provided at the corner of the shank 340. The groove 341 includes a first portion 341a having a first width, and a second portion 341b having a second width that is greater than the first width. The second portion 341b is in communication with the first portion 341a. The second portion 341b has a rectangular cross-sectional shape. As a result, the groove 341 has a T shape.

Accordingly, the tip 350 received in the groove 341 has a shape corresponding to that of the groove 341. That is, the tip 350 has a projection 352 having a rectangular cross-sectional shape.

Referring to FIGS. 13 and 14, the tip 350 is inserted into the groove 341 in a first direction. In particular, the projection 352 of the tip 350 is inserted into the second portion 341b of the groove 341 so that separating the tip 350 from the groove 341 in a second direction that is substantially perpendicular to the first direction is prevented with more secure structure compared to the structures in FIGS. 5 and 10.

Additionally, an adhesive 343 may be coated on an inner wall of the groove 341. The tip plate 300 may be employed in the rotor and the vertical shaft impact crusher in FIGS. 7 and 8.

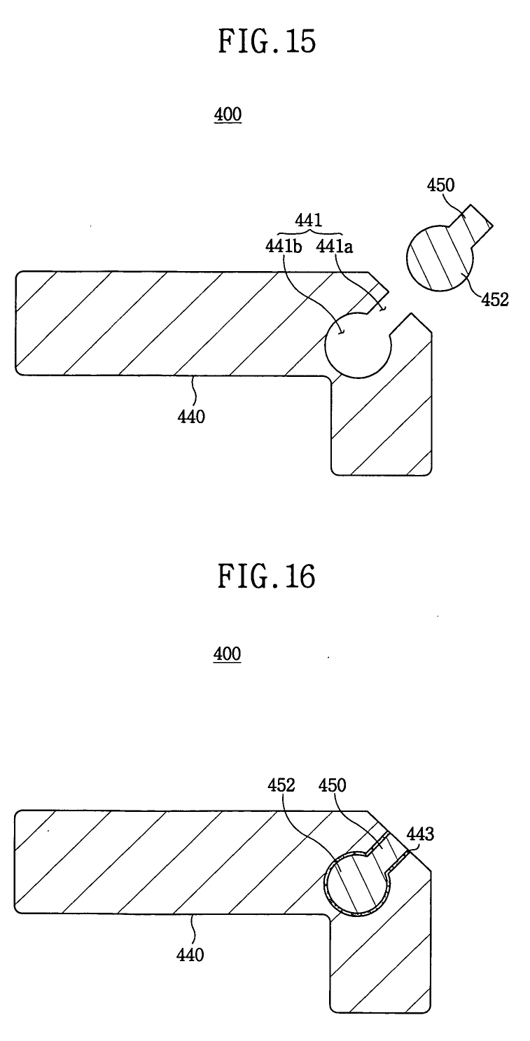

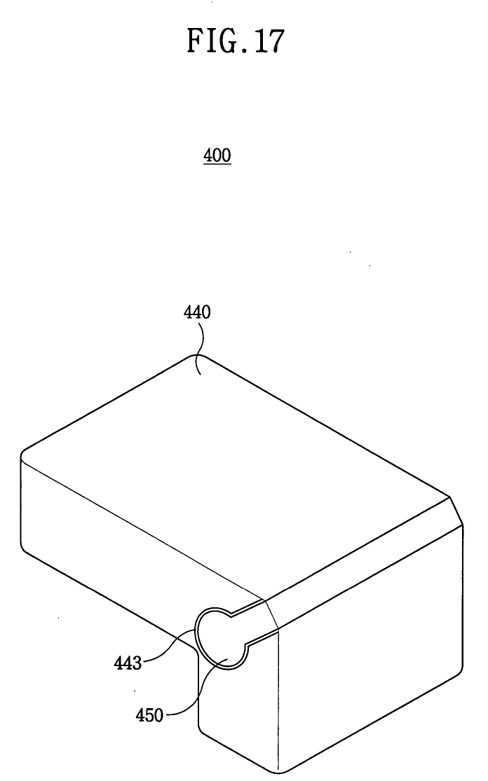

FIG. 15 is an exploded cross sectional view illustrating a tip plate in accordance with a fourth embodiment of the present invention. FIG. 16 is a combined cross sectional view illustrating the tip plate in accordance with the fourth embodiment of the present invention. FIG. 17 is a perspective view illustrating the tip plate in accordance with the fourth embodiment of the present invention.

Referring to FIG. 15, a tip plate 400 in accordance with a fourth embodiment of the present invention includes a shank 440 having a bent portion, and a tip 450 combined with the shank 440. The tip 450 including tungsten carbide prevents the shank 440 from wearing.

A groove 441 for receiving the tip 450 is provided at the corner of the shank 440. The groove 441 includes a first portion 441a having a first width, and a second portion 441b having a second width that is greater than the first width. The second portion 441b is in communication with the first portion 441a. The second portion 441b has a circular cross-sectional shape.

Accordingly, the tip 450 received in the groove 441 has a shape corresponding to that of the groove 441. That is, the tip 450 has a projection 452 having a circular cross-sectional shape.

Referring to FIGS. 16 and 17, the tip 450 is inserted into the groove 441 in a first direction. In particular, the projection 452 of the tip 450 is inserted into the second portion 441b of the groove 441.

Additionally, an adhesive 443 may be coated on an inner wall of the groove 441. The tip plate 400 may be employed in the rotor and the vertical shaft impact crusher in FIGS. 7 and 8.

Although the groove having the above-mentioned shapes in the embodiments is illustrated, it is noted that the shape of the groove may not be restricted within the above-mentioned shapes. The tip plate having the groove, which has the upper width and the lower width greater than the upper width, may be included in the scope of the present invention.

According to the present invention, since the groove has the upper width and the lower width greater than the upper width, the tip is directly combined with the shank without applying the silver solder.

Therefore, a blazing process for heating the silver solder is excluded in the present invention. As a result, cracking the tip owing to a high temperature in the blazing process is prevented. The tip having a high hardness may be used so that the life span of the tip plate is extended.

Having described the preferred embodiments of the present invention, it is noted that modifications and variations can be made by persons skilled in the art in light of the above teachings. It is therefore to be understood that changes may be made in the particular embodiment of the present invention disclosed which is within the scope and the spirit of the invention outlined by the appended claims.

1. A tip plate of a rotor comprising:
a shank disposed at an exit of the rotor that provides a centrifugal force to an aggregate, the shank including a groove that has an upper width adjacent to a surface of the shank and a lower width greater than the upper width; and
a tip received in the groove for preventing the shank from being worn by the aggregate, the tip having a shape corresponding to the groove.

2. The tip plate of claim 1, wherein the shank has a bent portion, and the groove is provided at the bent portion.

3. The tip plate of claim 1, wherein a width of the groove gradually increases from an upper portion to a lower portion.

4. The tip plate of claim 1, wherein the groove comprises a first portion having the upper width, and a second portion in communication with the first portion and having the lower width.

5. The tip plate of claim 4, wherein a cross-sectional shape of the second portion comprises a dove tailed shape, a rectangular shape or a circular shape.

6. The tip plate of claim 1, further comprising an adhesive coated on an inner wall of the groove.

7. A vertical shaft impact crusher comprising:
a crushing chamber;
a feeding hopper disposed over the crushing chamber for introducing an aggregate into the crushing chamber;
a rotor disposed in the crushing chamber for providing a centrifugal force to the aggregate; and
an anvil mounted on an inner wall of the crushing chamber, the aggregate crushing against the anvil,
wherein the rotor comprises
a rotor housing in communication with the feeding hopper, the rotor housing being rapidly rotatable to provide the centrifugal force to the aggregate;
guiding plates disposed in the rotor housing for guiding the aggregate, the guiding plates providing an exit through which the aggregate is discharged at a side face of the rotor housing;
a shank mounted on an end of the guiding plates adjacent to the exit, the shank including a groove that has an upper width adjacent to a surface of the shank and a lower width greater than the upper width; and
a tip received in the groove for preventing the shank from being worn by the aggregate, the tip having a shape corresponding to the groove.

8. The vertical shaft impact crusher of claim 7, wherein a width of the groove gradually increases from an upper portion toward a lower portion.

9. The vertical shaft impact crusher of claim 7, wherein the groove comprises a first portion having the upper width, and a second portion in communication with the first portion and having the lower width.

10. The vertical shaft impact crusher of claim 7, further comprising an adhesive coated on an inner wall of the groove.

11. The vertical shaft impact crusher of claim 7, further comprising a distribution member disposed in the rotor housing for distributing the aggregate toward the anvil.
